(19) United States
(12) Patent Application Publication
(10) Pub. No.: US 2009/0254860 A1
(43) Pub. Date: Oct. 8, 2009

(54) METHOD AND APPARATUS FOR PROCESSING WIDGET IN MULTI TICKER

(75) Inventors: Joon-kyu SEO, Seoul (KR); Seung-chul SHIN, Gangneung-si (KR); Hye-young SEONG, Suwon-si (KR); Kyoung-nyo HWANGBO, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/246,739

(22) Filed: Oct. 7, 2008

(30) Foreign Application Priority Data
Apr. 3, 2008 (KR) 10-2008-0031383

(51) Int. Cl. G06F 3/048

(52) U.S. Cl. 715/810

(57) ABSTRACT

Provided are a method and apparatus for processing a multi widget that unitively manages/displays various widgets in a multi ticker. The method includes registering predetermined widgets, analyzing information types of the registered widgets, determining a display type of widget information according to the information types of the registered widgets, and displaying the corresponding widget information on a screen according to the display type of the widget information.

### CROSS-REFERENCE TO RELATED PATENT APPLICATION

This application claims priority from Korean Patent Application No. 10-2008-0031383, filed on Apr. 3, 2008, in the Korean Intellectual Property Office, the disclosure of which is incorporated herein in its entirety by reference.

### BACKGROUND OF THE INVENTION

1. Field of the Invention

Apparatuses and methods consistent with the present invention relate to a widget service, and more particularly, to processing a multi widget that unitively manages/displays various widgets in a multi ticker, and an apparatus for processing the multi widget.

2. Description of the Related Art

Recently, webpage information have been used in conjunction with end-user devices such as desktop videos (DTVs) or mobile devices. Such devices can use various information of a webpage by using only one widget.

A widget may be a small graphic user interface instrument that operates according to an application program of a computer operating system (OS) and displays various images on a computer screen of an apparatus. Also, the widget may be a small window that receives information from the Internet and displays information on a screen of an apparatus. Accordingly, various functions provided by a browser, for example, Internet Explorer®, such as a clock, a calendar, a memo pad, a search window, a map, news, a real-time camera window, or the like, are provided through a widget without opening the browser.

In this case, a user arranges various widgets, such as a clock, a calendar, a memo pad, a search, a map, news, a real time camera window, or the like, on a screen of the apparatus.

However, the widgets arranged on the screen of the apparatus may cover the entire screen. Thus, to select the desired widget from among the widgets on the screen, the user uses a control means, such as a remote control device.

### SUMMARY OF THE INVENTION

The present invention provides a method of processing a widget in a multi ticker so that various widget information can be displayed in a small area by unitively managing and displaying various widgets in the multi ticker, and an apparatus for processing the widget in the multi ticker.

According to an aspect of the present invention, there is provided a method of processing a widget in a multi ticker, the method including: registering predetermined widgets; analyzing information types of the registered widgets; determining a display type of widget information according to the information types of the registered widgets; and displaying the corresponding widget information on a screen according to the display type of the widget information.

According to another aspect of the present invention, there is provided an apparatus for processing a widget in a multi ticker, the apparatus including: an information analyzing unit analyzing an information type of a registered widget; a storage unit storing a display type of widget information; a displaying unit displaying the widget information; an information receiving unit receiving the widget information; and a control unit determining the display type of the widget information according to the information type of the widgets analyzed in the information analyzing unit, and displaying the corresponding widget information, received from the information receiving unit, in a predetermined order, on the displaying unit according to the display type of the widget information.

### BRIEF DESCRIPTION OF THE DRAWINGS

The above and other aspects of the present invention will become more apparent by describing in detail exemplary embodiments thereof with reference to the attached drawings in which:

FIG. 1 is a conceptual diagram of a multi widget management system according to an exemplary embodiment of the present invention;

FIG. 2 is a block diagram of an apparatus for processing a multi widget according to an exemplary embodiment of the present invention;

FIG. 3 is a flowchart of a method of processing a widget in a multi ticker according to an exemplary embodiment of the present invention;

FIGS. 4A and 4B are flowcharts of methods of displaying widget information according to exemplary embodiments of the present invention;

FIG. 5 is a conceptual diagram of an automatic method of displaying widget information according to an exemplary embodiment of the present invention;

FIG. 6 is a conceptual diagram of a manual method of displaying widget information according to an exemplary embodiment of the present invention;

FIGS. 7A through 7D illustrate the displaying of various widgets in a multi ticker according to exemplary embodiments of the present invention; and

FIG. 8 illustrates a widget set menu for managing various widgets in a multi ticker according to an exemplary embodiment of the present invention.

### DETAILED DESCRIPTION OF EXEMPLARY EMBODIMENTS OF THE INVENTION

Hereinafter, exemplary embodiments of the present invention will be described in detail with reference to the accompanying drawings.

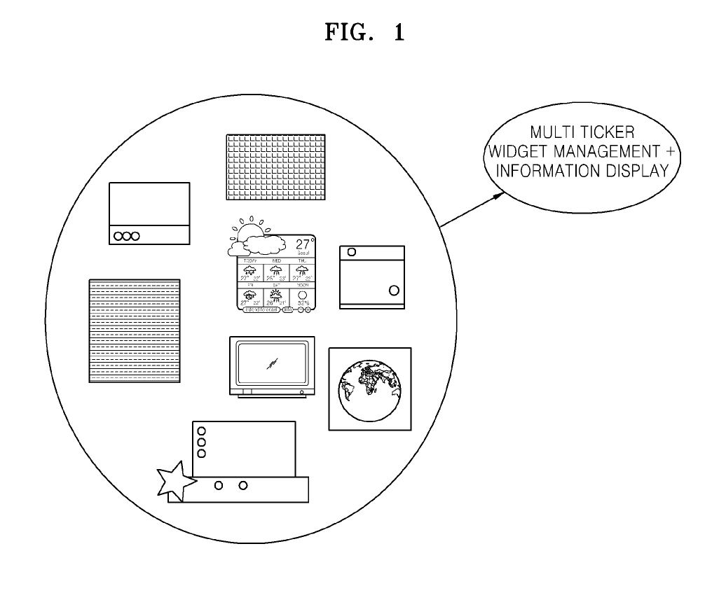

FIG. 1 is a conceptual diagram of a multi widget management system according to an exemplary embodiment of the present invention.

Referring to FIG. 1, the multi widget management system unitively manages various widgets in a multi ticker, automatically or manually displays information of the widgets, and edits contents related to the information of the widgets. Accordingly, various widgets are unitively managed in a multi ticker and the widgets are displayed in a predetermined order in one display area, so that various widgets can be displayed in a small area.

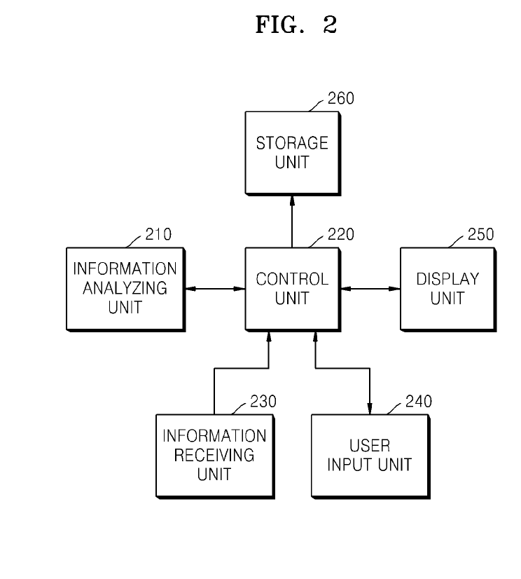

FIG. 2 is a block diagram of an apparatus for processing a multi widget according to an exemplary embodiment of the present invention.

The apparatus for processing the multi widget includes an information analyzing unit 210, a control unit 220, an information receiving unit 230, a user input unit 240, a display unit 250, and a storage unit 260.

The information analyzing unit 210 identifies the type of widget information newly registered in the control unit 220 and transmits the identified type of the widget information to the control unit 220.

That is, the information analyzing unit 210 analyzes meta data or header information included in the widget and extracts properties of webpage information or information on contents included in the widget, for example, movies, images, texts, etc. Here, the widget information may be received from a webpage or may be embodied in the widget via an internal independent program.

The information receiving unit 230 receives the widget from a wired/wireless network or updates the widget information at a predetermined period.

The user input unit 240 may use various devices, such as a key pad, a mouse, a touch screen, or the like, and includes a plurality of number keys, character keys, at least one functional key, etc., so that a user may generate a key signal for selecting a user's desired function or inputting information. In particular, the user input unit 240 includes up, down, left, and right buttons, which are used to select and move the widget information, and a widget set menu button for editing the widget.

The storage unit 260 maps the display type of the widget information determined by the control unit 220 with the corresponding widget, and then stores the display type of the widget information. Here, the display type of the widget information may correspond to the display position, size, and properties of the contents to be displayed on a screen.

The display unit 250 may be a liquid crystal display (LCD), or the like, and displays various information, signals, etc., that are extracted and generated during the control process of the control unit 220. In particular, the display unit 250 displays the corresponding widget information in a predetermined information type, such as a movie type, a text type, or the like, at a predetermined position.

The control unit 220 manages the registered various information and controls the widget information display. That is, the control unit 220 receives the widget or the updated widget information from the information receiving unit 230, determines the display type of the widget information by using the type of the widget information analyzed in the information analyzing unit 210, and displays the corresponding widget information in a predetermined order on the display unit 250 according to the display type of the widget information. Also, when a key signal for changing the widget is inputted to the control unit 220 from the user input unit 240, the control unit 220 displays the corresponding widget information on the display unit 250 on the basis of the display type of the widget information.

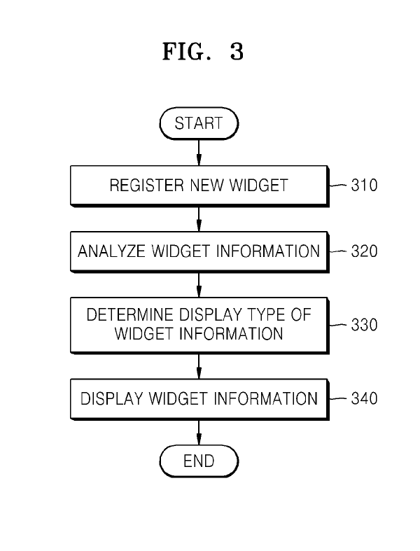

FIG. 3 is a flowchart of a method of processing a widget in a multi ticker according to an exemplary embodiment of the present invention.

First, a new widget received from a webpage or an independent program type of widget is registered (Operation 310)

Next, the type of webpage information or contents information included in the registered widgets is analyzed, and then properties of the webpage information or contents information are extracted (Operation 320). Here, the type of the widget information may include a movie, a still image, a text, etc., according to a widget category. For example, when the type of the widget information may be a “new” widget, the type of the contents information is text.

Next, the display type of the widget information being displayed on the screen is determined on the basis of the type of the widget information analyzed through the registered widget (Operation 330).

Here, the display type of the widget information may include the display position, size, and properties of the contents to be displayed on a screen. For example, when the display type of the widget information is a “news” widget consisting of texts, a position coordinate of the widget to be displayed on the screen, the size of the texts, etc., may be determined. The display type of the widget information is mapped with the corresponding widget category and then is stored in a memory. The registered widgets and the information display type of each widget are stored in the memory.

Then, the corresponding widget information is displayed at a specified position of a screen according to the display type of the widget information (Operation 340). The widget information is updated at a predetermined period and is displayed on the specified screen. Also, the method of displaying the widget information can be a manual display method or an automatic display method according to whether a key signal for changing information by a user is detected or not. The two methods can be used to display the corresponding widget information on the screen.

Here, in the manual display method, information displayed on the screen may be moved by using a remote or up, down, left and right buttons included in a touch screen. For example, the up and down buttons are used to move between widgets, and the left and right buttons are used to move between the information in the widgets.

Also, if widget information to be displayed on the screen exists, the automatic display method displays widget information in a widget display area set at a specified position of the screen by successively moving the widget information from the right side to the left side.

Also, if a widget set menu is requested, a screen of the widget set menu for performing editing, such as selecting, registering, or deleting the widget, is generated.

Also, if a user clicks the widget information display area, the widget information display area may be enlarged to a predetermined size.

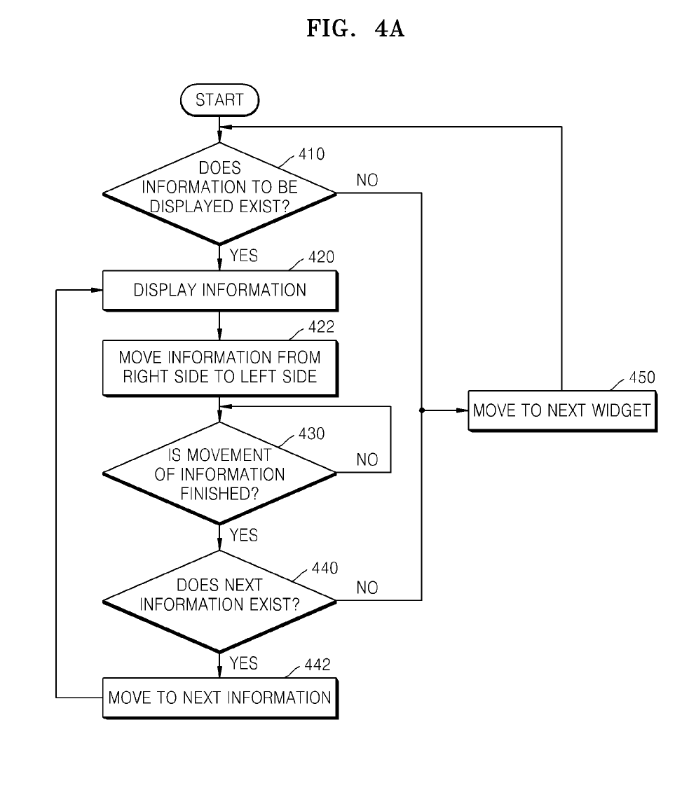

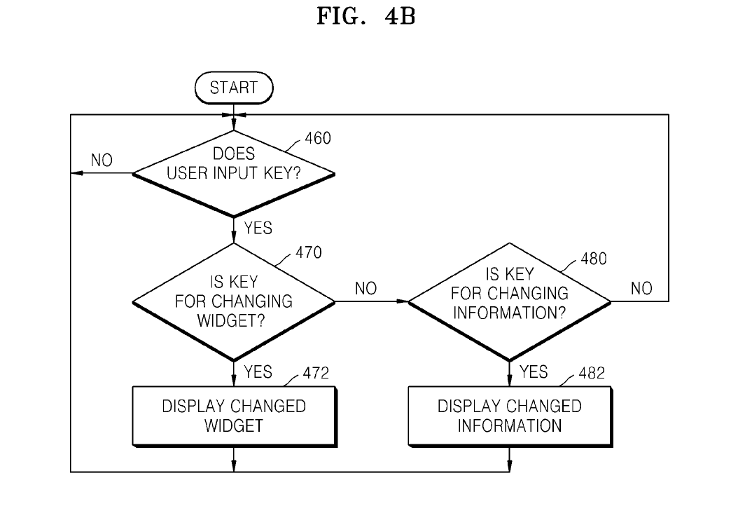

FIG. 4A is a flowchart of an automatic display method. 3 according to an exemplary embodiment of the present invention.

First, it is assumed that a plurality of widgets are registered and a plurality of contents information are included in the widgets.

Next, it is checked whether contents information to be displayed on a screen exists or not in a specified widget (Operation 410).

Next, if the contents information to be displayed on the screen exists in the specified widget, the contents information is displayed in the screen area that is pre-set (Operation 420).

Next, the contents information displayed on the screen is moved from the right side to the left side (Operation 422).

Next, it is checked whether the movement of the contents information has been finished or not (Operation 430). If the movement of the contents information has been finished, it is checked whether the next contents information exists or not in a specified widget (Operation 440).

Next, if the next contents information exists in the specified widget, the method proceeds to the next contents information (Operation 442), and Operations 420 through 440 are continuously performed.

Here, if the contents information to be displayed on the screen does not exist in the specified widget, the method proceeds to the next widget (Operation 450), and a display process with respect to the contents information of the next widget is performed.

Therefore, in exemplary embodiments of the present invention, various widgets are displayed in a predetermined order in one multi ticker.

FIG. 4B is a detailed flowchart of a manual display method according to an exemplary embodiment of the present invention.

First, it is checked whether a user key is inputted (Operation 460).

Next, it is checked whether the user key is a key for changing a widget (Operation 470).

Here, if the user key is a key for changing a widget, the changed widget is displayed on the screen (Operation 472).

Next, if the user key is not a key for changing a widget, it is checked whether the user key is a key for changing information (Operation 480).

Here, if the user key is a key for changing information, the changed contents information in a specified widget is displayed on the screen (Operation 482).

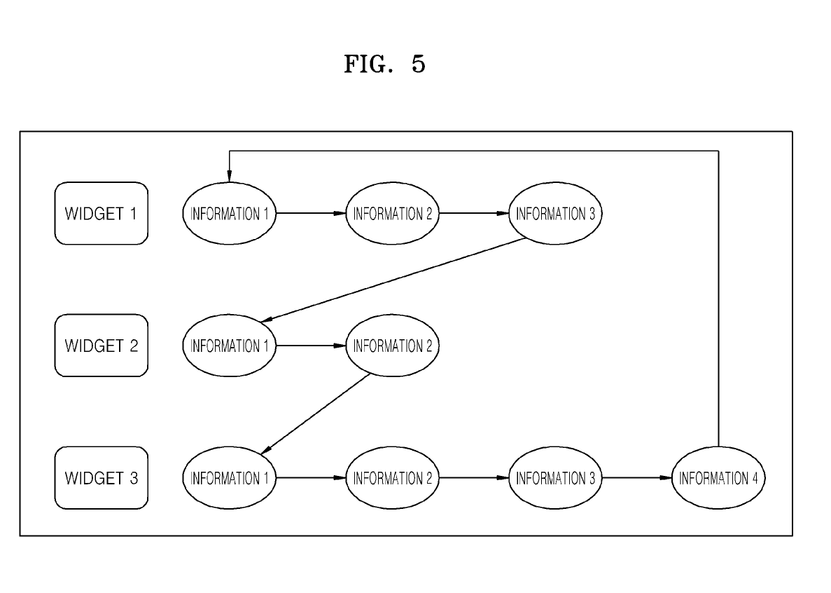

FIG. 5 is a conceptual diagram of an automatic display method of FIG. 3 according to an exemplary embodiment of the present invention.

First, it is assumed that a first widget, a second widget, and a third widget are registered. Also, it is assumed that the first widget includes information 1, information 2, and information 3, the second widget includes information 1 and information 2, and the third widget includes information 1, information 2, information 3, and information 4.

Referring to FIG. 5, the information 1, the information 2, and the information 3 in the first widget are sequentially moved and displayed on a screen. Next, after the information 3 in the first widget is displayed, the information 1 and the information 2 in the second widget are sequentially moved and displayed on the screen. Then, after the information 2 in the second widget is displayed, the information 1, the information 2, the information 3 and the information 4 in the third widget are sequentially moved and displayed on the screen. After the information 4 in the third widget is displayed, the information in the first widget are sequentially moved and displayed again.

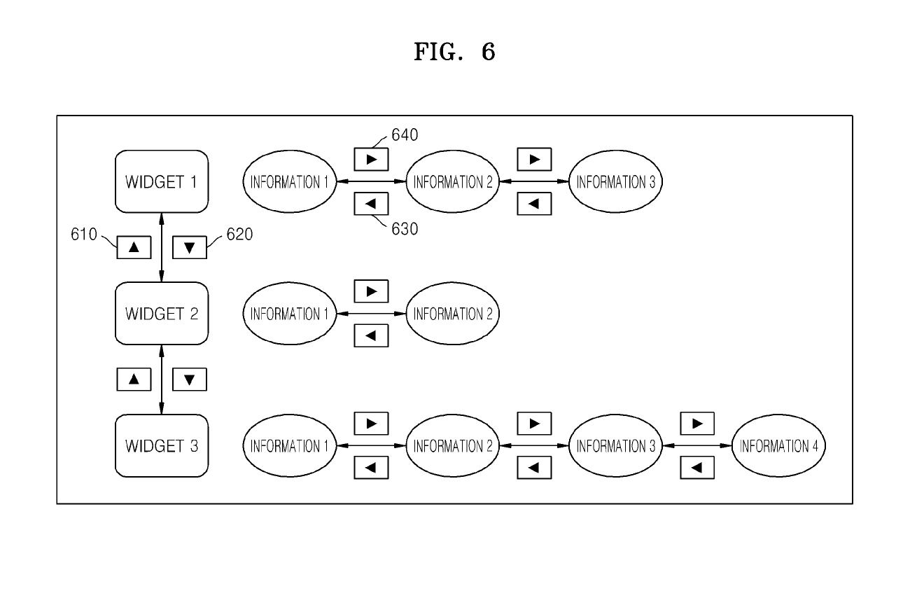

FIG. 6 is a conceptual diagram of a manual display method according to an exemplary embodiment of the present invention.

Information of widgets displayed on a screen are moved using up, down, left and right buttons included in a remote or a touch screen.

Referring to FIG. 6, movement between first, second, and third widgets is performed using up and down buttons 610 and 620, and movement of the information in the widgets is performed using left and right buttons 630 and 640. For example, when the up button 610 is pushed, the first widget (widget 1) is displayed on a screen, and when the down button 620 is pushed, the second widget (widget 2) is displayed on a screen. Also, when the left button 630 is pushed, the information 1 of the first widget is displayed on a screen, and when the right button 640 is pushed, the information 2 of the first widget is displayed on a screen.

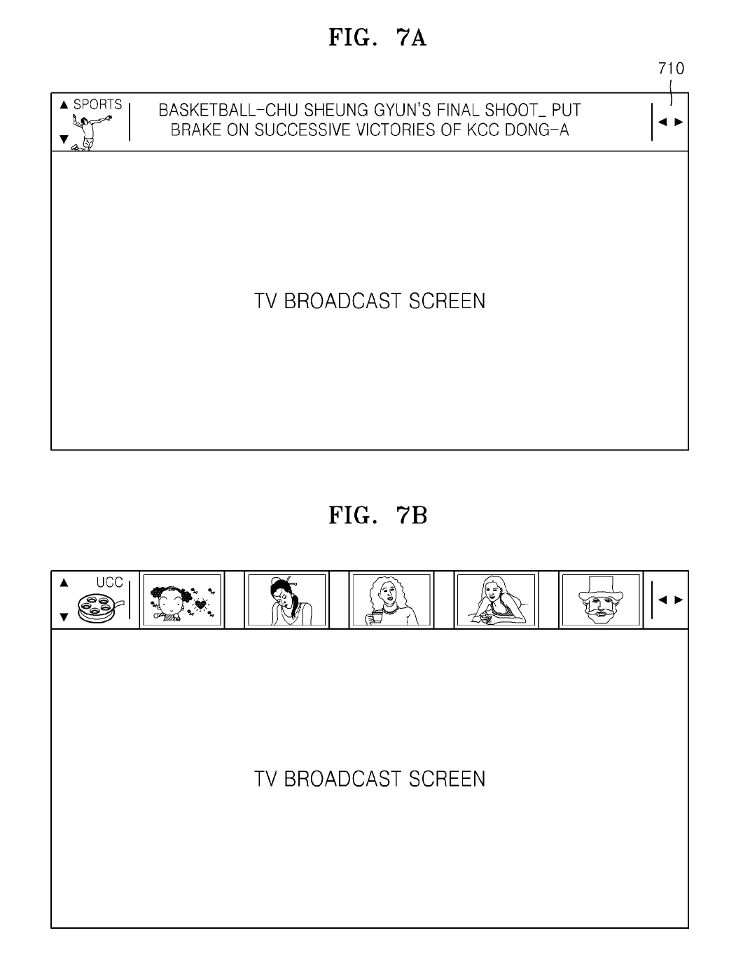

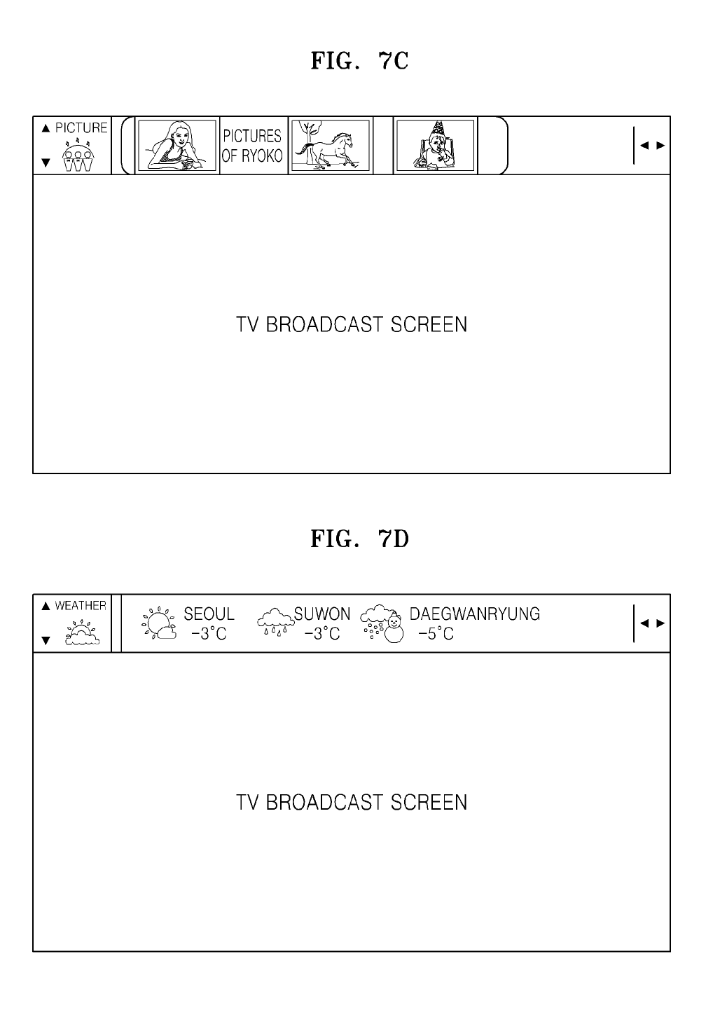

FIGS. 7A through 7D illustrate the displaying of various widgets in a multi ticker according to exemplary embodiments of the present invention.

Referring to FIG. 7A, the multi ticker displays “sports” widget information on an upper part of a TV broadcast screen by using pre-stored text type information. Here, the widget information continuously receives new news information from a webpage and is updated and displayed on the screen. The news information moves from the left side to the right side of the screen in the updated order. Contents of the news information may be manually moved from the left side to the right side of the screen by using a left-right movement button 710 displayed on the screen.

Also, a widget information display area may be enlarged by a key-operation.

Referring to FIG. 7B, the multi ticker displays “movie” widget information on the upper part of the TV broadcast screen by using pre-stored movie type information. Here, the movie widget information is moved from the left side to the right side of the screen at n second intervals.

Referring to FIG. 7C, the multi ticker displays “image” widget information on the upper part of the TV broadcast screen by using pre-stored still image type information. Here, the image widget information is grouped for each user and displayed on the screen. Here, a still image corresponding to the image widget information is moved from the left side to the right side of the screen at n second intervals.

Referring to FIG. 7D, the multi ticker displays “weather” widget information on the upper part of the TV broadcast screen by using the still image and text type information. Here, the weather widget information continuously receives new weather information from a webpage and is updated.

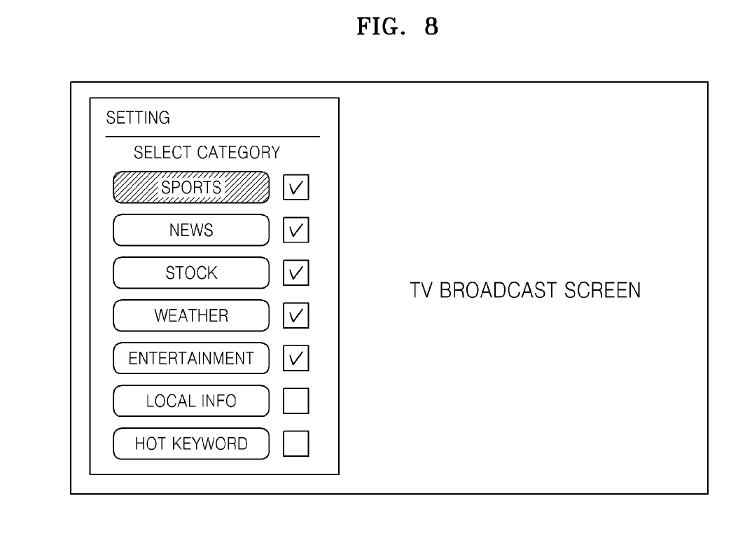

FIG. 8 illustrates a widget set menu for managing various widgets in a multi ticker according to an exemplary embodiment of the present invention.

First, a separate widget set menu button for performing editing, such as selecting, registering, or deleting a widget, is installed in a device.

When a user pushes the widget set menu button, the multi ticker displays a widget set menu for selecting a widget category to be displayed on a TV broadcast screen. For example, when the user selects “sports”, “news”, “stock”, “weather”, or “entertainment” (by marking “√”), the multi ticker displays contents of the “sports” widget on the TV broadcast screen at the beginning, and then sequentially and automatically displays contents information of the other widgets selected by the user.

According to exemplary embodiments of the present invention, in a user end apparatus, such as a desktop video (DTV) or a mobile device, various widgets are unitively managed in a multi ticker, so that various widget information can be displayed in a small area.

The invention can be also embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD_ROMs, magnetic tapes, floppy disks, and optical data storage devices.

Alternatively, in another exemplary embodiment, the computer readable recording medium can be carrier waves (such as data transmission through the Internet).

The computer readable recording medium can also be distributed over network coupled computer systems so that the computer readable code is stored and executed in a distributed fashion.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of processing a widget in a multi ticker, the method comprising:
registering a plurality of widgets;
analyzing information types of the registered widgets;
determining a display type of widget information according to the information types of the analyzed widgets; and
displaying corresponding widget information on a screen according to the display type of the widget information.

2. The method of claim 1, wherein the analyzing the information types of the registered widgets comprises extracting properties of contents included in the widgets.

3. The method of claim 1, wherein the determining the display type of the widget information comprises determining a display position, size, and properties of contents to be displayed on the screen according to the information types of the widgets.

4. The method of claim 1, wherein the displaying the widget information comprises displaying updated information of a corresponding widget periodically received from a network, according to the display type of the widget information.

5. The method of claim 1, wherein the displaying the widget information is performed using a manual display method or an automatic display method according to whether or not a key signal for changing a user information is detected.

6. The method of claim 1, wherein the displaying the widget information comprises moving information in a corresponding widget in a direction at a position of the screen and displaying the information, and after all the information in the corresponding widget is displayed, moving to a next widget and displaying a next widget information.

7. The method of claim 1, wherein the displaying the widget information comprises:
checking whether or not display information of a specified widget exists;
displaying the corresponding widget information if the display information of the specified widget exists;
moving the displayed information in a direction on the screen;
performing movement of a next widget information after the movement of the displayed information is completed; and
if display information of the specified widget does not exist, an information movement process for a next widget is initiated.

8. The method of claim 1, wherein the displaying the widget information comprises performing movement between information in a first one of the widgets or between the widgets at a position of the screen by using a movement button and displaying the information.

9. The method of claim 1, further comprising generating a widget set menu screen for selecting and deleting the widget.

10. The method of claim 1, wherein the displaying the widget information comprises enlarging a display area of the screen to a predetermined size when a user selects a display area of the widget information.

11. The method of claim 1, wherein the displaying the widget information comprises displaying desired widget information, formed by combining the display type of the widget information and upgraded information of a corresponding widget, on the screen.

12. An apparatus for processing a widget in a multi ticker, the apparatus comprising:
an information analyzing unit which analyzes an information type of a widget;
a storage unit which stores a display type of widget information;
a displaying unit which displays the widget information;
an information receiving unit which receives the widget information; and
a control unit which determines the display type of the widget information according to the information type of the widget analyzed in the information analyzing unit, and displays a corresponding widget information received from the information receiving unit on the displaying unit according to the display type of the widget information.

13. The apparatus of claim 12, further comprising a user input unit which generates a key signal for moving or selecting the widget information.

14. The apparatus of claim 12, further comprising a widget set menu button for editing the widget.

15. A computer-readable recording medium having embodied thereon a program for executing a method of processing a widget in a multi ticker, the method comprising:
registering a plurality of widgets;
analyzing an information type of the registered widgets;
determining a display type of widget information according to the information type of the analyzed widgets; and
displaying corresponding widget information on a screen according to the display type of the widget information.
